(19) United States
(12) Patent Application Publication
(10) Pub. No.: US 2004/0041316 A1
(43) Pub. Date: Mar. 4, 2004

(54) Method and damping device for absorbing an undesired vibration

(76) Inventors: Jens Hofschulte, Lehrte (DE); Norbert Scherm, Bremen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/362,603

(22) PCT Filed: Aug. 29, 2001
(86) PCT No.: PCT/DE01/03229

(30) Foreign Application Priority Data
Aug. 31, 2000 (DE) 100 43 128.3

(51) Int. Cl. F16M 1/00

(52) U.S. Cl. 267/136; 267/140.15

(57) ABSTRACT

A method and a damping device for absorbing an undesired vibration, in particular, a tremor or an oscillation, in which a base is decoupled from the vibration by a positioning actuator. A control unit registers a relative displacement of the foot and a mass caused by the vibration as a deflection of a spring element that links the foot to the mass. There is thus no need for a reference system that acts independently of the vibration to control the positioning actuator, allowing the damping device to be produced at relatively low cost. The time-delayed transfer from the spring element to the mass is also exploited to counteract the vibration before it has an undesired effect on the base.

The present invention relates to a method for absorbing an undesired excitation, in particular a tremor or a vibration, the excitation being detected by a sensor and a signal for a positioning actuator being generated using a control unit, in order to thus avoid transmission of the excitation to a base. Furthermore, the present invention relates to a device for performing the method.

Such a method and a device provided for this purpose are used in practice in order to keep interfering tremors away from sensitive technical devices. Ground tremors or tremors due to airborne noise have a particularly interfering effect in this case. Impairments caused in this way are to be found, for example, in measurement and laser technology, and in hard drives of data storage systems (head crash) or even in the noticeable restriction of the driving comfort for an occupant of a motor vehicle.

Further typical fields of application for damping devices are the shielding of sensitive sensors, particularly in experimental arrangements or inertially stabilized systems in the field of defense or monitoring technology and for use in the transport of hazardous materials or patients, as well as generally to increase comfort in personal conveyance.

Technical systems are already frequently protected from vibrations with the aid of springs. Such passive systems are inadequate, particularly due to their transmission behavior in the event of low-frequency interference.

For high-precision systems, damping devices are used in which the tremor is detected by acceleration sensors and compensated using the positioning actuator. However, this method is typically unsuitable at high frequencies, since the positioning actuator has an upper limiting frequency. The operating range of the system is therefore delimited by the bandwidth of the positioning sensor. In this case, the problem particularly results in the known devices that the undesired excitation is first detected by the sensor on the base supporting the structure, i.e., the vehicle body of a motor vehicle, for example. Before the countermovement suitable for compensation may be initiated by the positioning actuator, the excitation is already detectable to the occupants, so that the influence of the excitation may be restricted using such a device, but may not be prevented.

A device in which an additional mass is elastically connected to the system to be damped using a positioning actuator for damping over an increased frequency range is also already known from German Patent Application 197 25 770 A1. Using the positioning actuator, forces are to be produced between the elastic system and the mass of the damping device in addition to the mass on the system, in order to thus withdraw vibration energy from the system. The comparatively high outlay which is connected to the detection of the excitation and the driving of the mass by the positioning actuator has been shown to be disadvantageous in this case.

Furthermore, an active damping device in which interfering vibrations are kept away from the base in that the positioning actuator is moved with equal deflection in the opposite direction to the excitation, while a spring element stabilizes the base, is known from U.S. Pat. No. 4,531,699.

Japanese Patent 22 25 839 has already disclosed a damping device in which an acceleration sensor detects a filtered range of the excitation. The signal detected in this way is converted into an opposing input signal for a piezoactuator, so that the oscillations may cancel one another out.

Furthermore, U.S. Pat. No. 4,566,118 describes a method for vibration damping, in which an excitation is extinguished in a specific range in that a second excitation, synchronized with the first excitation, is generated. A vibration sensor having a filter is used for this purpose.

Furthermore, an active vibration reducer having a controllable magnetic bearing to achieve a desired damping effect is also disclosed by German Patent Application 196 21 700 A1.

In spite of the multiple known damping devices which are typical in practice, the problem unsolved until now in combating undesired excitation has been that an acceleration sensor or a reference system is necessary in order to be able to produce a signal for the positioning actuator through a compensation. Such a reference system which is not influenced by the excitation may, however, only be implemented at a high cost.

The present invention is based on the object of absorbing the undesired excitation without a costly reference system being necessary for this purpose. In this case, the efficiency of the method is to be increased at the same time. Furthermore, a device for performing the method is to be provided.

The first object stated is achieved according to the present invention with a method according to the features of claim 1.

Therefore, a method is provided according to the present invention in which the excitation is first initiated in a mass and transmission of the excitation from the mass to the base is prevented in that a relative movement between the mass and the excitation is detected by the sensor and the specific signal for a movement opposite to the mass intended for the positioning actuator is generated therefrom. In this way, the excitation first only acts on the mass, a relative movement between the initiated movement and the mass, which is essentially based on the mass inertia, being detected by the sensor. The transmission of this excitation acting on the mass to the base is prevented using the positioning actuator, in that a countermovement is initiated at the correct time. Because the excitation only works on the mass after a delay, the positioning actuator may be driven in such a way that transmission of the excitation to the base may be counteracted at the correct time, so that the base may be kept completely at rest. In this way, the excitation is not merely weakened, but compensated even before undesired influence on the base, so that transmission from the mass to the base is prevented.

In this case, an embodiment of the method according to the present invention in which the deflection of a spring element which transmits the excitation to the mass is detected to determine the relative movement is particularly advantageous. In this way, the deformation of the spring caused by the excitation is detected in order to determine a signal for the positioning actuator through the control unit using the sensor. In this case in particular, in contrast to an acceleration sensor, which is necessary according to the related art, only a displacement sensor is necessary, so that in addition to lower production cost, an improvement of the efficiency for low-frequency oscillations, which may only be detected by an acceleration sensor with unsatisfactory precision, is achieved at the same time. For this purpose, the spring element may, for example, be positioned on a pickup, so that in this way the relative movement between the pickup and the mass may be detected as a distance changed by the excitation.

Another advantageous alteration of the present invention is provided if the relative speed between the mass and the excitation is detected. In this way, a speed sensor known according to the related art may be used easily, through which the relative speed between the mass and a pickup moved by the excitation is determined. The measured value detected in this way is converted into a corresponding control variable for the positioning actuator, so that an effect of the excitation on the base is prevented.

Another advantageous alteration of the method according to the present invention may be achieved if a relative rotational movement between the mass and the excitation is detected by the sensor. In this way, an undesired torsional vibration may be prevented according to the same method. In this case, the excitation acts on the mass using a torsion spring, for example, whose relative rotational speed(s) is/are detected by the sensor and subsequently used as an input signal for the positioning actuator, embodied as an angular positioning actuator in this case.

The second object described, of providing a damping device for performing the method, for absorbing an undesired excitation, particularly a tremor or a vibration, having a base supporting a structure whose distance from a mass moved by the excitation, which is positioned between the base and the location, is changeable using a positioning actuator, and having a control unit, using which a signal for the positioning actuator may be generated from a measured variable detected by a sensor, the mass being arranged movably in relation to the location of the undesired excitation and this relative movement being detectable by the sensor and a signal intended for the positioning actuator able to be generated therefrom, is achieved according to the present invention in that the excitation may first be initiated in the mass and transmission of the excitation from the mass to the base is prevented by a movement opposing the mass. In this way, a costly reference system may be dispensed with, since knowing the absolute position of the mass influenced by the excitation is unnecessary. In this case, only the relative movement of the excitation as an interfering movement and the movement of the mass caused thereby, which is possibly delayed, are determined for the sensor to detect a signal. This relative movement may be determined with significantly higher precision in this case than through a conventional acceleration sensor. At the same time, the damping device made in this way may be implemented using relatively simple technical means.

An especially advantageous refinement of the present invention is provided if the mass is movable using a spring element. In this way, the interfering movement connected to the excitation is exclusively transmitted to the mass through the spring element. Accordingly, a deformation of the spring element corresponding to the spring constant results, from which the relative movement between a pickup of the spring, which faces away from the mass, and the mass may be derived.

For this purpose, the relative speed may be detected during the deflection of the spring element, in order to thus determine the appropriate signal for the positioning actuator using the control unit. Another especially advantageous embodiment of the present invention is achieved, in contrast, if the deflection of the spring element is detectable. In this way, only the distance, which is changed by the excitation, between a base point and a fixed point of the spring element connected to the mass is determined, in order to thus, using the control unit, calculate the force acting due to the excitation.

Another especially advantageous embodiment of the damping device is also provided if the mass is arranged movably in relation to the excitation using a magnetic field. In this way, the position of the mass may be selected via a regulator, so that contactless positioning is achieved. The precision of the controller may thus be increased further, since the system parameters necessary for this purpose are reproducible with high precision. The excitation is detected in this case as a change of the parameters of the magnetic field and/or as a change of the position of the mass.

It is also especially favorable for this purpose if the positioning actuator has a controllable magnetic bearing. Through suitable driving of the positioning actuator implemented in this way, rapid and precise movement may be achieved, through which the base may be kept free of undesired excitation. The parameters of the magnetic bearing, which are known per se, may be processed exactly with the aid of the controller, so that a further increase of the efficiency may be achieved.

Another very advantageous embodiment of the present invention is achieved if the mass is positioned so it is rotationally movable and a relative rotational movement between the mass and the excitation is detectable by the sensor. In this way, a damping device for a torsional vibration or excitation is provided, through which the vibrations arising in motors, for example, may be compensated easily. For this purpose, a torsion spring may be used, using which the mass may be kept movably in a predetermined rest position relative to the excitation.

In this case, an especially effective alteration of the present invention is achieved if the relative angle of rotation between the mass and the excitation is detectable by the sensor. In this way, the relative movement between the mass and the excitation may be detected with a precision which is not achievable by a conventional acceleration sensor. In this case, a reference system is not necessary. It is also conceivable to provide a magnetic field instead of a spring element in this case, through which undesired frictional influences may be avoided in particular.

In this case, a further, especially expedient embodiment of the present invention is achieved if the damping device has multiple positioning actuators acting on a shared base, each having an assigned sensor. In this way, different excitations initiated at different parts of the base may be detected and reliable compensation of the position and/or position stabilization may be achieved through the individual positioning actuators.

The high sensitivity of the speed sensor also opens further fields of application. Since the movement of the lower mass may be reconstructed by the damping device, the form of excitation may also be determined with the aid of an expanded controller. This allows determination of the relative foundation movement. The acceleration of the excitation may also be determined by differentiating the signal of the speed sensor. An acceleration sensor implemented in this way has a higher sensitivity and a lower production cost than the sensors known according to the related art.

The present invention permits various embodiments. One of them is illustrated in the drawing and described in the following for further clarification of its basic principle.

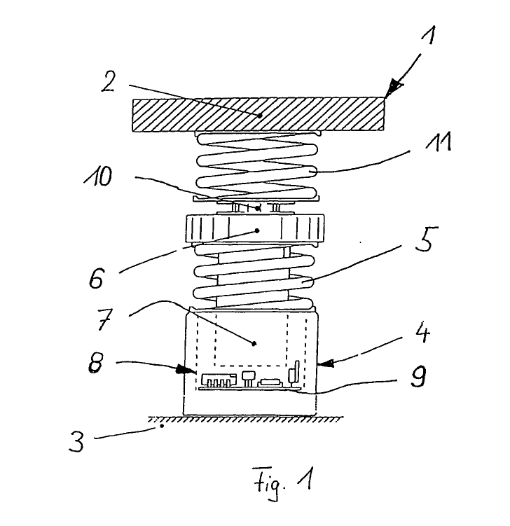

FIG. 1 shows a damping device according to the present invention in a front view;

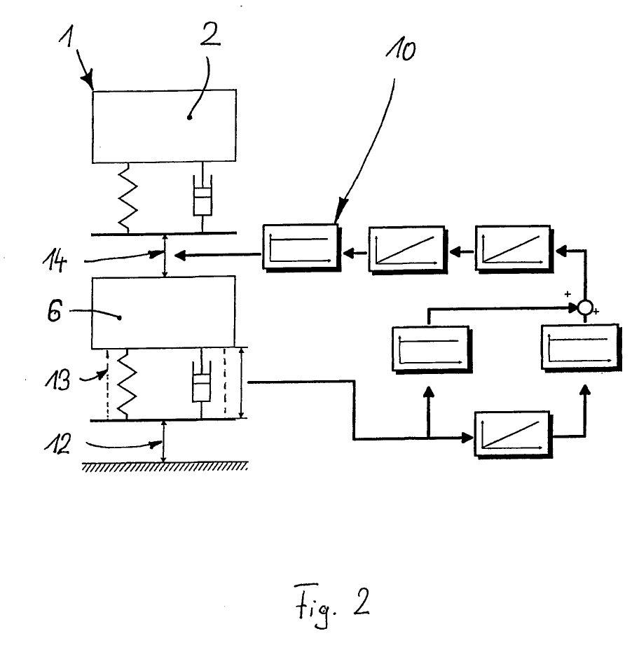

FIG. 2 shows a circuit diagram of the damping device;

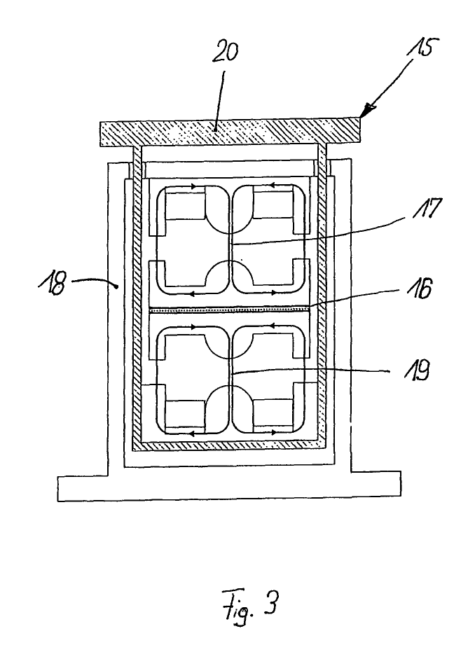

FIG. 3 shows a further damping device having a magnetic bearing in a schematic drawing.

FIG. 1 shows a front view of the damping device 1 having a base 2 which is intended for a structure (not shown) to be protected from an undesired excitation, for example, a tremor or a vibration. The excitation acts via a foundation 3 on a pickup 4 (foot) of the damping device 1, which is thus moved vertically through an unknown path. Using a spring element 5, the force effect caused by the excitation is transmitted to a mass 6, whose column 7 in the pickup 4 is movable both upward and downward essentially unimpeded. In this case, the force effect leads to a deflection of the spring element 5, which is detectable using a sensor 8 as a relative movement between the column 7 and the pickup 4. The measured variable obtained in this way is subsequently converted using a control unit 9 into a signal for a positioning actuator 10 connected to the mass 6, which produces a vertical length change. The absolute value of this length change corresponds to the excitation, its movement direction being opposite. Therefore, the excitation does act on the mass 6, but is compensated by the positioning actuator 10 in such a way that a reaction on the base 2 is prevented. For this purpose, the positioning actuator 10 is equipped with a connection means 11 embodied as a spring element, in order to thus counteract a possible reaction of the base 2 on the mass 6.

The spring element 5 allows a movement of the mass 6 which is different from the excitation. The deflection of the spring element 5 arising in this case is detected by the sensor 8 and converted using the control unit 9 into a signal for the positioning actuator 10, a reference system, particularly for determining the relative position as a result of the excitation, not being necessary. Because the relative movement of the mass 6 is delayed in relation to the excitation, the compensation movement may be initiated by the positioning actuator 10 before the excitation is detectable on the base 2.

The precise mode of operation is described in further detail with reference to FIG. 2, which shows a circuit diagram of the damping device 1. An excitation, shown as the vertical interference 12, is shown first. This excitation acts on the mass 6 via the spring element 5 illustrated in FIG. 1 and/or the movable column 7 of the corresponding schematically illustrated spring-damper system 13 in the pickup 4. The distance detected in this case, which is changed in relation to the rest position, is calculated on the basis of the idealized movement compensation of the spring-damper system 13 as an input variable for the positioning actuator 10, illustrated here only by its functional equation. Through the positioning actuator 10, a time-dependent correction distance 14, which corresponds to the absolute value of the interference 12, is set between the base 2 and the mass 6, in order to thus avoid an effect of the interference 12 on the base 2.

Both continuous generation and time-discrete generation are conceivable for the signal for the positioning actuator 10. In this case, complete imaging of the unloaded spring-mass system which is exact over the entire frequency range is not absolutely necessary if the practical requirements do not require this high a precision.

FIG. 3 shows a further damping device 15, in which a mass 16 is kept in a suspended arrangement in a predetermined rest position by a magnetic bearing 17. An excitation is detected in this case as a change of the parameters of the magnetic field, through which the relative movement between the mass 16 and a pickup 18 may be determined. A control variable for a positioning actuator 19, also implemented as a magnetic bearing, is calculated therefrom, in order to thus be able to initiate a countermovement. A base 20 of the damping device 15 is therefore not influenced by and decoupled from the undesired excitation.

What is claimed is:

1. A method of absorbing an undesired excitation, in particular a tremor or a vibration, the excitation being detected by a sensor and a signal for a positioning actuator being generated using a control unit, in order to thus avoid transmission of the excitation to a base, characterized in that the excitation is first initiated in a mass and transmission of the excitation from the mass to the base is prevented in that a relative movement between the mass and the excitation is detected by the sensor, and a signal for a movement opposed to the mass, intended for the positioning actuator, is generated therefrom.

2. The method according to claim 1, characterized in that the deflection of a spring element which transmits the excitation to the mass is detected.

3. The method according to claim 1 or 2, characterized in that the relative speed between the mass and the excitation is detected.

4. The method according to at least one of the preceding claims, characterized in that a relative rotational movement between the mass and the excitation is detected by the sensor.

5. A damping device (1, 15) for absorbing an undesired excitation, in particular a tremor or a vibration, having a base (2, 20), which supports a structure, whose distance from a mass (6, 16), which is movable by the excitation and is positioned between the base (2, 20) and the location (foundation 3), is changeable using a positioning actuator (10, 19), and having a control unit (9), using which a signal for the positioning actuator (10, 19) may be generated from a measured variable detected by a sensor (8), the mass (6, 16) being arranged movably in relation to the location (foundation 3) of the undesired excitation and this relative movement being detectable by the sensor (8) and a signal intended for the positioning actuator able to be generated therefrom, characterized in that the excitation may first be initiated in the mass (6, 16) and transmission of the excitation from the mass (6, 16) to the base (2, 20) is prevented by a movement opposed to the mass (6, 16).

6. The damping device (1) according to claim 5, characterized in that the mass (6) is movable by the excitation using a spring element (5).

7. The damping device (1) according to claim 6, characterized in that the deflection of the spring element (5) is detectable.

8. The damping device (15) according to at least one of claims 5 to 7, characterized in that the mass (16) is arranged so it is relatively movable in relation to the excitation using a magnetic field.

9. The damping device (15) according to at least one of claims 5 to 8, characterized in that the positioning actuator (19) has a controllable magnetic bearing.

10. The damping device according to at least one of claims 5 to 9, characterized in that the mass is arranged so it is rotationally movable and a relative rotational movement between the mass and the excitation is detectable by the sensor.

11. The damping device according to claim 10, characterized in that the relative angle of rotation between the mass and the excitation is detectable by the sensor.

12. The damping device (1, 15) according to at least one of claims 5 to 11, characterized in that the damping device (1, 15) has multiple positioning actuators (10, 19) acting on a shared base (2, 20), each having an assigned sensor (8).
